(19) United States
(12) Patent Application Publication
(10) Pub. No.: US 2004/0183644 A1
(43) Pub. Date: Sep. 23, 2004

(54) Cores and core laminations for electromagnetic devices

(76) Inventor: Omri Fishbein, (US)

Correspondence Address: NATTER & NATTER, 25 WEST 43 STREET, NEW YORK, NY, 10036, US

(21) Appl. No.: 10/766,280

(22) Filed: Jan. 27, 2004

(30) Foreign Application Priority Data
Jan. 30, 2003 (IL) 154,199

(51) Int. Cl. H01F 27/24

(52) U.S. Cl. 336/234

(57) ABSTRACT

A core lamination for electromagnetic devices, including a substantially T-shaped central member constituted by a crossbar and a post, the post having at least two notches, one on each side of its lower portion; first and second side members, each of the side members constituted by a post and a foot, each foot having a tooth-like projection at its end; wherein, for assembly, the first and second side members are placed on the left and the right, respectively, of the T-shaped central member, with the tooth-like projections engaging the respective notches on the post of the central member.

### FIELD OF THE INVENTION

The present invention relates to cores and core laminations utilized in electromagnetic devices. In particular, the present invention is suitable for ballast cores and stray-field transformers for discharge lamps.

### BACKGROUND OF THE INVENTION

Magnetic core laminations, which are stamped from electrical steel strip, must meet at least the following demands: their shape must be such that the cores made from them are magnetically efficient, that is, have a favorable, uniform flux configuration, and they must be inexpensively produced, that is, permit a scrapless strip layout. A further demand is that the coil-windows of the core will have optimal proportions, to be selectable during the design stage. A still further demand is ease of assembly, with no need for welding, screws, rivets and the like, for keeping the parts together.

None of the prior art cores fully meet all of the above-mentioned demands. They are either well-designed with regard to flux configuration and coil-window proportions, but have a strip layout that produces a certain amount of scrap, or they have a scrapless strip layout but unfavorable window dimensions, and require a plurality of fasteners or brackets. The well-known T and 2L configuration, for instance, comprises a lamination with a substantially scrapless layout and many other advantages; however, the assembly of the core is complicated and requires at least welding, clamps or fasteners at both ends of the core, in order to securely hold its parts together.

### DISCLOSURE OF THE INVENTION

It is one of the objects of the present invention to overcome the above-mentioned difficulties and drawbacks, and to provide a three-part core lamination having all of the advantages of the T and 2L lamination, together with an additional, very significant advantage in its assembly.

The invention achieves the above objective by providing a core lamination for electromagnetic devices, comprising a substantially T-shaped central member constituted by a crossbar and a post, said post having at least two notches, one on each side of its lower portion; first and second side members, each of said side members constituted by a post and a foot, each said foot having a tooth-like projection at its end; wherein, for assembly, said first and said second side members are placed on the left and the right, respectively, of said T-shaped central member, with said tooth-like projections engaging the respective notches on the post of said central member.

The lamination of the present invention can be designed to yield coil windows of arbitrarily selected proportions, without impairing its other features. Therefore, space can be provided for two or more coils separated by magnetic shunts, thus facilitating the design and production of stray-field transformers and ballasts.

### BRIEF DESCRIPTION OF THE DRAWINGS

The invention will now be described in connection with certain preferred embodiments with reference to the following illustrative figures so that it may be more fully understood.

With specific reference now to the figures in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 illustrates the T-shaped central member of the lamination according to the invention;

FIG. 2 is an enlarged view of detail A in FIG. 1;

FIGS. 3 and 4 illustrate the L-shaped member and its mirror image;

FIG. 5 illustrates a core assembled from the laminations of FIGS. 1, 3 and 4;

FIG. 6 is an enlarged view of detail B in FIG. 5;

FIG. 7 illustrates the strip layout of the core lamination members of FIGS. 1, 3 and 4;

FIG. 8 is an enlarged view of detail C in FIG. 7;

FIG. 9 illustrates a further embodiment of lamination members for an electro-magnetic core, and

FIG. 10 is an enlarged view of the detail D of FIG. 9.

### DETAILED DESCRIPTION

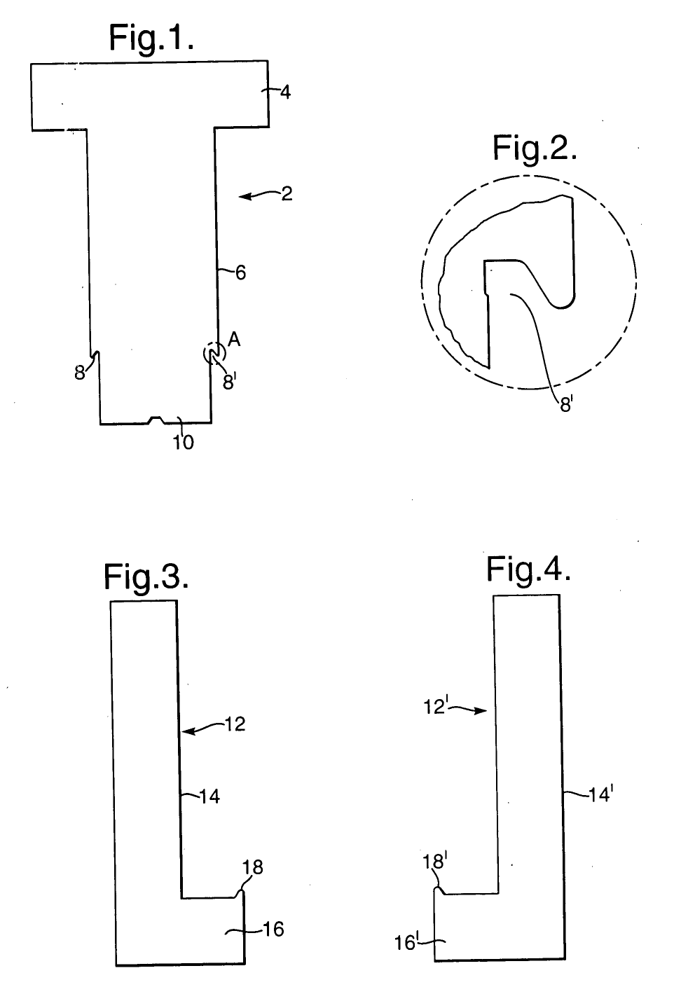

Referring now to the drawings, there is seen in FIG. 1 a first element of the lamination according to the present invention, consisting of a T-shaped central member 2 constituted by a crossbar 4 and a post 6. Post 6 has two notches: notch 8 at the left side of its lower portion 10, and notch 8′, which is preferably a mirror image of notch 8, at the right side of lower portion 10.

FIG. 2 is an enlarged view of detail A in FIG. 1, showing notch 8′.

The second element of the lamination according to the invention, shown in FIG. 3, is an L-shaped side member 12, constituted by a post 14 and foot 16 provided with a tooth-like projection 18 at its end. The third element of the lamination is a mirror image 12′ of L-shaped side member 12, shown in FIG. 4, provided with a tooth-like projection 18′ at the end of foot 16′. Each projection 18, 18′ is insertable into a respective notch of post lower portion 10 of T-shaped central member 2. The three elements are punched out from electrical steel strip, using the strip layout explained further below.

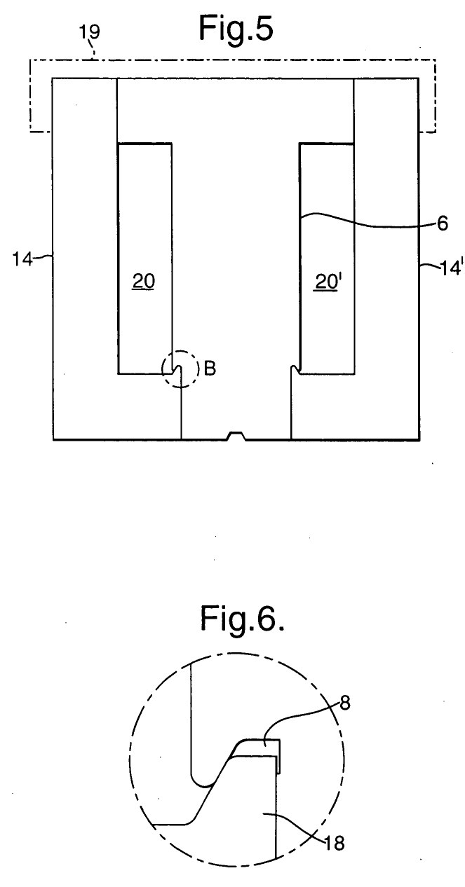

A view of the core assembled by stacking the above-described elements is shown in FIG. 5. It can be seen that the stacked T-shaped central member 2, the L-shaped side member 12 and its mirror image 12′, are held together at the lower end of the core by the projections 18, 18′ and notches 8, 8′, and that the assembly requires only one external clamping means 19 at its upper end. It is also seen that the three members 2, 12, 12′ now define two rectangular openings or windows 20, 20′, which provide space for the coils of the final product, e.g., a ballast for a discharge lamp. These windows 20, 20′ have a height-to-width ratio which can be arbitrarily selected at the design stage to be the most favorable, as far as the effectiveness and ease of manufacture of the coils (and magnetic shunts, if any) are concerned.

FIG. 6 is an enlarged view of detail B in FIG. 5, showing the interlocking of notch 8 and projection 18.

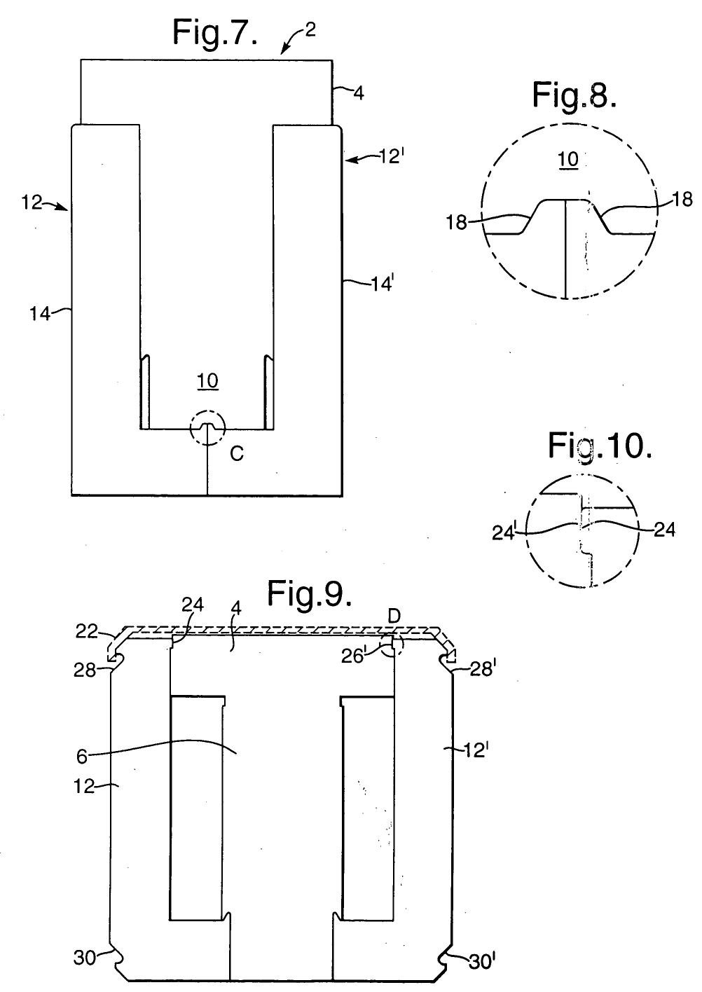

FIG. 7 illustrates the strip layout made possible by the design and. relative dimensions of the three lamination members 2, 12, 12′. It is seen that, in the interlocking layout, posts 14, 14′ of the L-shaped and mirror-image members 12, 12′ fill the windows 20 (FIG. 5), nearly fully tessellating the strip. In other words, the layout is practically scrapless and there is only a minimal waste of material.

FIG. 8 is an enlarged view of detail C in FIG. 7, showing how the projections 18, 18′ are cut from lower portion 10.

Referring to FIGS. 9 and 10, there is shown the T-shaped central member 2, the L-shaped side members 12, 12′ and the clamping means 22 (shown by broken lines). According to this embodiment, each of the edges of the cross-bar 4 of the T-shaped central member 2, as well as the edges of the side members 12, 12′ are formed with matching shoulders 24, 24′, 26, 26′, facilitating improved clamping between the laminate members. Such improved clamping results in a decrease of acoustic noise emanating from the core and the parasite air gaps therebetween.

Advantageously, the corners and the outside edges of the L-shaped side members 12, 12′ are formed with notches 28, 28′, 30, 30′, enabling a more positive attachment of clamping means 22 for the purpose of stronger gripping of the members together, as well as for the coupling of the entire core to a luminaire, a post, a wall, or the like.

While the illustrated embodiment of the invention is particularly suitable for use with ballasts for discharge lamps, it should be understood that the laminations according to the invention are also suitable for other devices, e.g., such as transformers.

It will be evident to those skilled in the art that the invention is not limited to the details of the foregoing illustrated embodiments and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed is:

1. A core lamination for electromagnetic devices, comprising:
a substantially T-shaped central member constituted by a crossbar and a post, said post having at least two notches, one on each side of its lower portion;
first and second side members, each of said side members constituted by a post and a foot, each said foot having a tooth-like projection at its end;
wherein, for assembly, said first and said second side members are placed on the left and the right, respectively, of said T-shaped central member, with said tooth-like projections engaging the respective notches on the post of said central member.

2. The core lamination as claimed in claim 1, wherein said first side member is substantially L-shaped and said second side member is substantially a mirror image of said first side member.

3. The core lamination as claimed in claim 1, wherein edges of said T-shaped central member and said side members are formed with matching shoulders.

4. The core lamination as claimed in claim 1, wherein edges of the side members are formed with notches facilitating gripping of the side members by clamping means.

5. A core for an electromagnetic device, assembled from the core lamination as claimed in claim 1.

6. The core as claimed in claim 5, further comprising clamping means for securely holding said core together.
